(19) United States
(12) Patent Application Publication
(10) Pub. No.: US 2010/0182518 A1
(43) Pub. Date: Jul. 22, 2010

(54) SYSTEM AND METHOD FOR A DISPLAY SYSTEM

(76) Inventors: Noel J. Kirmse, Bellevue, WA (US); Joseph Ungari, Bellevue, WA (US)

Correspondence Address: KENYON & KENYON LLP, ONE BROADWAY, NEW YORK, NY, 10004, US

(21) Appl. No.: 12/355,184

(22) Filed: Jan. 16, 2009

(51) Int. Cl. H04N 5/64

(52) U.S. Cl. 348/836; 348/E05.128

(57) ABSTRACT

A system and method provide an interactive display screen which may be fitted or associated with a container or vessel. In an embodiment, the display screen is wrapped around or configured to surround entirely or partially a host object. In a further embodiment, the display screen is activated by a received signal from a sensor associated with the display screen, a remote activation signal, or a simple press of an activation button by a user. In an embodiment, the display screen is configured to exhibit media such as email(s), text message(s), photo(s) and/or video(s) received from a mobile device and/or other locations.

### FIELD OF INVENTION

The present invention relates generally to enhancing social interaction between persons, and, more specifically, to providing a dynamic display system including a telecommunication transmission associated with an object.

### BACKGROUND

Informal social gatherings between individuals at coffee shops and other public locations have increased over time. Such social gatherings can be a comfortable place for friends and acquaintances to meet and converse with each other. At such gatherings, photos of family members, friends, vacation excursions, and the like, may be shared. In addition, participation in multiplayer games and activities, e.g., chess, also may take place. Such sharing and gaming activities provide for an enhanced social experience. Accordingly, there exists a need to facilitate the efficiency and ease of such sharing and gaming activities.

### SUMMARY OF THE INVENTION

The present invention provides a system and method for transmitting a communication from a device to an object, the object then displaying the received communication. The example system and method may include any number of other components needed to facilitate a digital image display, such as a processor, memory, etc. The example system and method may include an activation mechanism such as a standard button, a touch-screen button, and/or an environmental sensor configured to detect changes in weight, temperature, moisture, etc. The example system and method may include a data transfer mechanism to exchange data with external sources and between example systems. The example system and method may include access to the Internet and/or any other external network. The example system and method may interface with a cellular communication device, and provide extended functionality associated with such devices. For example, a device may have caller ID, game(s), stored video, streaming video from a baby monitor, etc. which can then be transmitted to the container display device for display.

An embodiment of the present invention is a beverage container whose receiving and/or display functions are activated by a sensor (e.g., sensor to detect weight, temperature, moisture, etc.). The beverage container includes an image display device which, e.g., displays an image when there is matter or liquid present in the beverage container. In an embodiment, the sensor activates only when the material in the beverage container reaches, is below, and/or is above a predefined level.

An embodiment of the present invention provides a system and/or method for a visual display device having a visual display, wherein the visual display device is configured to be associated with a container and the visual display device includes an activation mechanism. At least one connector (e.g., mechanical device, chemical device, adhesive, clip, latch, screw, gel, wire, string, hook-and-loop fastener, molded attachment, welding, etc.) or other method (e.g., magnet, force/attraction system, or other means) is configured to cause the visual display device to be associated with the container. A memory is associated with the visual display device and adapted to store digital content. A data transfer device is associated with the visual display device for at least one of transmitting data and receiving data wirelessly. In an embodiment, the activation mechanism is responsive to at least one of: weight, temperature, liquid, pressure, and motion. In an embodiment, the visual display device is attached to the container using at least one connector or other available method for close association.

In an embodiment, at least one side of the container is curved, and the visual display device is configured to be attached to the at least one side of the container that is curved. In an embodiment, the visual display device is substantially similar in shape to the at least one side of the container that is curved. In an embodiment, the visual display device is flexible. In an embodiment, at least one side of the container is substantially flat, and the visual display device is configured to be connected to the at least one side of the container that is substantially flat. In an embodiment, the data transfer device is configured to send and receive data to and from another device responsive to the container coming in contact with the other device. In an embodiment, the visual display device is configured to display at least one of: images, video, news, weather, a graphical user interface, game displays, maps, traffic conditions, user information, a personal profile, a dating profile, a social networking profile, consumer information, recipes, beverage information, nutritional values, and a Web browser.

In an embodiment, the container is configured to contain a second container. In an embodiment, the container is configured with a hollow portion adapted to contain a quantity of matter, and the visual display responds according to the quantity of matter contained within the hollow portion of the container. In an embodiment, the quantity of matter is a quantity of liquid having a surface (e.g., an upper surface or other defined surface), and the visual display responds according to one of: only displaying a portion of the visual display that is below the surface and only displaying a portion of the visual display that is above the surface. In an embodiment, the container is adapted to hold at least one permeable substance, and wherein the activation mechanism is responsive to a moisture quantity in the at least one permeable substance. In an embodiment, a speaker is connected to the memory and adapted to produce audio responsive to accessing at least some of the data contained in the memory. In an embodiment, the visual display device is attached to a container. The visual display device may be removably attached to the container.

An embodiment of the present invention provides a system and/or method for receiving visual data responsive to an activation mechanism wirelessly; and displaying the visual data on a visual display device associated with a container responsive to the activation mechanism. The activation mechanism is a sensor which activates at least one of the receiving of and the displaying of visual data. In an embodiment, the sensor is responsive to at least one of: weight, temperature, liquid, pressure, and motion. In an embodiment, at least one side of the container is curved, and the displaying occurs on the at least one side of the container that is curved. In an embodiment, the displaying includes a display surface that is curved. In an embodiment, the display surface is substantially similar in shape to the at least one side of the container that is curved. In an embodiment, at least one side of the container is substantially flat, and wherein the visual display device is connected to the at least one side of the container that is substantially flat. In an embodiment, the transmitting occurs with a second device and is at least responsive to the container coming in contact with the second device. In an embodiment, the visual entity includes at least one of: images, video, news, weather, a graphical user interface, game displays, maps, traffic conditions, user information, a personal profile, a dating profile, a social networking profile, consumer information, recipes, beverage information, nutritional values, and a Web browser. In an embodiment, the container is configured to hold a second container. In an embodiment, the container is configured with a hollow portion adapted to contain a quantity, and the displaying includes adjusting the visual entity according to the quantity contained within the hollow portion of the container. In an embodiment, the quantity is a quantity of liquid having a surface, and wherein the adjusting includes one of: only displaying a portion of the visual entity that is below the surface and only displaying a portion of the visual entity that is above the surface. In an embodiment, the container is adapted to hold at least one permeable substance, and wherein the activation mechanism is responsive to a moisture quantity in the at least one permeable substance. In an embodiment, audio responsive to accessing at least some of the data contained in a memory associated with the visual display device is produced.

### BRIEF DESCRIPTION OF THE DRAWINGS

FIG. 1A shows an example device according to an embodiment of the present invention.

FIG. 1B shows an example device according to an embodiment of the present invention.

FIG. 2 is a block diagram which shows an example device according to an embodiment of the present invention.

FIG. 3 shows an example procedure according to an embodiment of the present invention.

FIG. 4 shows an example procedure according to an embodiment of the present invention.

FIG. 5 shows an example configuration of an example system according to an embodiment of the present invention.

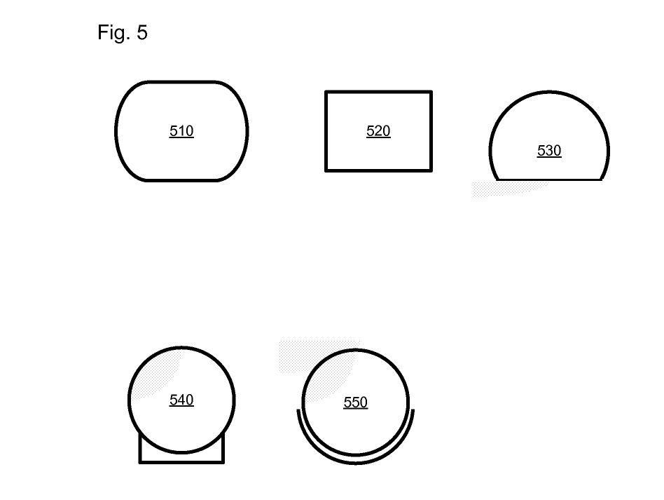

### DETAILED DESCRIPTION

The following description provides specific details for a thorough understanding of, and enabling description for, various embodiments of the technology. One skilled in the art will understand that the technology may be practiced without many of these details. In some instances, well-known structures and functions have not been shown or described in detail to avoid unnecessarily obscuring the description of the embodiments of the technology. It is intended that the terminology used in the description presented below be interpreted in its broadest reasonable manner, even though it is being used in conjunction with a detailed description of certain embodiments of the technology. Although certain terms may be emphasized below, any terminology intended to be interpreted in any restricted manner will be overtly and specifically defined as such in this Detailed Description section.

Example embodiments of the present invention includes one or more containers, each with an associated visual display device and an activation mechanism. Example containers include a mug or cup for hot/cold/room-temperature beverages, a vase, a planter/pot, a medicine container, a jar, a bottle, a carafe, a vessel suitable for holding disposable cup inserts, or any other container. Example display devices include a flat LCD panel, a curved LCD panel, electronic paper, e-ink, a LED display, an OLED display, or any other electronic display device. Example activation mechanisms include devices sensitive to weight, temperature, motion, pressure, NFC signals, RFID signals, light, moisture, sound, contact, devices that measure the passage of time, or any other type of activation mechanism. Example embodiments of the present invention include a deactivation mechanism responsive to the same or different sensitivity of the activation mechanism. For example, the device is activated based on the presence of a hot liquid, and then deactivated once the liquid cools to a certain temperature. Alternatively, the device remains on and/or activated despite cooling, and, e.g., deactivate based on the elapsing of time.

In an example embodiment, a container is configured to receive a second container (e.g., a disposable insert). The insert can be a paper cup, polystyrene cup, cardboard cup, and/or a disposable insert of any kind. Alternatively, the insert is not disposable, but configured as a reusable and/or removable insert. In an embodiment, an activation device and visual display device configured to respond to properties of the insert or the contents of the insert are provided. For example, the activation device is chosen to be sensitive to the level of a liquid contained in the insert, and sections of the visual display device activate in correspondence with the level of the liquid. In an embodiment, the activation device is sensitive to the temperature of a liquid contained in the insert, and sections of the visual display device activate when a liquid of a particular temperature or of a specific temperature range is detected.

An example embodiment of the present invention is configured to display an image, video, or any other visual content (e.g., animated .gif) upon activation. In an embodiment, the visual content is selected by the user from a repository of content stored locally or remotely. In an embodiment, the example embodiment is configured to select the content (e.g., randomly) for display. The content is stored locally in a memory device. The memory device is a RAM, EPROM, a hard disk drive, a solid state memory device, and or any other suitable memory device. For example, the memory device stores data received through a data transfer device such as a memory card, a USB device, a Bluetooth™ device, a wireless network card, a device capable of interfacing with a wireless communications network, and/or any other communications device. For example, a user stores a picture of the user's children in a memory device, and that picture is then transmitted to and displayed by an LCD panel when a temperature sensor detects a liquid above a certain temperature (e.g., seventy degrees Fahrenheit) within the container or removable insert (e.g., a paper cup) held by the container.

In an embodiment of the present invention, a device for producing audio is associated with the display vessel of the present invention. In an embodiment, the device is responsive to the activation mechanism, to instructions stored in a memory, and/or any other signal. For example, the activation mechanism is triggered by a sound pre-selected by the user. In an embodiment, this sound is stored in a memory, e.g., a solid state memory device, accessed through a communications device, or obtained by any other means. In an embodiment, one or more input devices are used. These devices, for example, include at least one of: touch sensitive panel, pressure sensitive panel, conventional button, a remote controller, and any other input device. For example, the container includes conventional buttons functioning so that a user can enter the name of the beverage, user, and/or anything else desired, in the container, causing such to be displayed on the visual display device of the container. For example, a bar manager transmits text from a device (e.g., a handheld telecommunications device, Internet account, personal computer, etc.) to pre-load beer mugs each having a display screen to display information about the various beers on-tap. Then, when a beverage is dispensed, the bartender can bring up that specific beverage in the system, allowing the consumer to view, read, and otherwise receive information about the beverage (e.g., nutritional information, history of the beverage or brewery, brewing process, etc.). For example, beverage information is stored on a memory device internal and/or external to the container. In an embodiment, a container allows for selection of image(s) and other material using available input device. In an embodiment, the container contents are determined by a sensor, and may utilize near field communication to identify the beverage (e.g., the container is physically “tapped” so that the system registers a specific beverage).

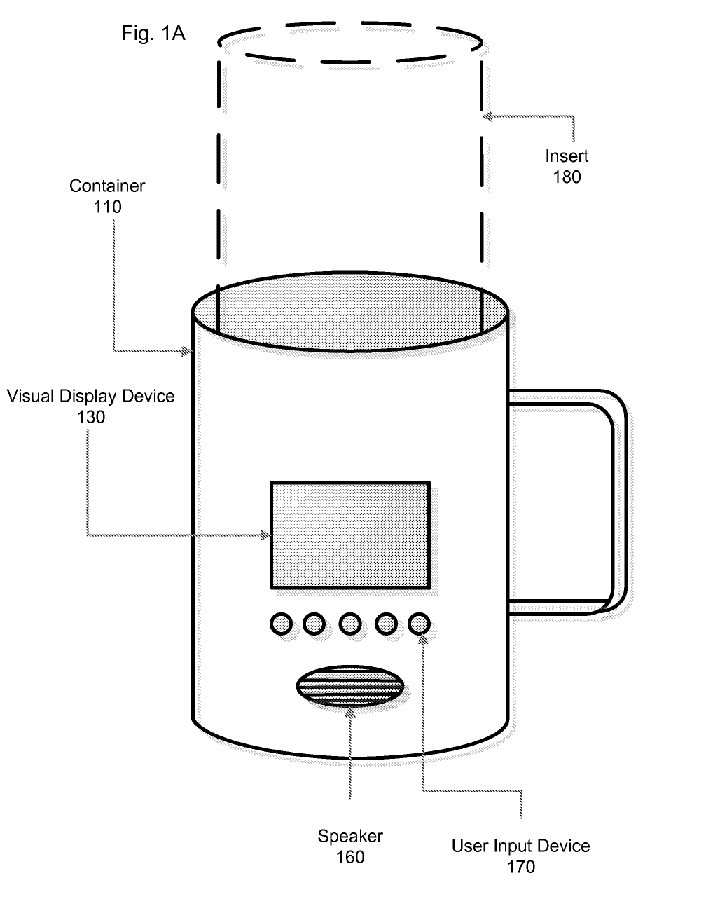

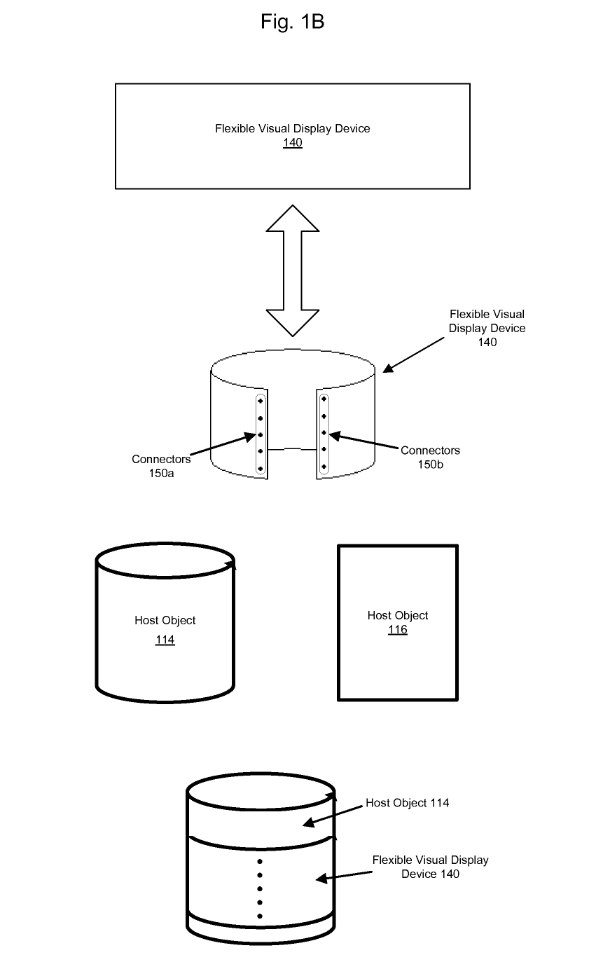

FIG. 1A illustrates an example embodiment of a container with an associated display device. The example embodiment of FIG. 1A is a beverage cup (e.g., a coffee mug). The container 110 may hold liquids or any matter having volume. In an embodiment, the container 110 has an associated insert piece 180. The insert piece may be a disposable cup, or a reusable insert (e.g., to facilitate cleaning the device). The container 110 includes a visual display device 130 and user input devices 170. In an embodiment, the container 110 includes a speaker 160 or other audio producing device. The audio producing device may play music or produce alerts as determined by the transmissions made to the container. It should be appreciated that the configuration of devices in FIG. 1A and other embodiments described herein is an example of the outlay of components in an example embodiment of the present invention. The system may include additional components or fewer components as described above, and these components can be arranged in any suitable configuration.

Example embodiments include one or more wireless communication devices (e.g., Bluetooth™). Such device(s) interface with the remote audio and/or visual device (e.g., a video-camera), allowing images obtained from such sources to be displayed on the visual display device of a container. In an embodiment, the system includes a speaker which produces audio received from such a device. For example, a Bluetooth™ device interfaces with a baby monitor. Audio and/or video obtained from the baby monitor is then transmitted in realtime to the container, which may then produce the audio and/or video via a speaker and/or visual display device associated with the container. In the example system, the activation mechanism is configured to be sensitive to certain signals from the baby monitor or other stimulus. In an embodiment, a coffee mug provides a suitable monitor of a sleeping child in another room. In an embodiment, a container displays streaming video from a television signal. In an embodiment, news, weather, stock quotes, traffic reports, and/or any other information wirelessly transmitted from a source to the container are displayed.

Another example embodiment of the present invention includes a container adapted to contain one or more plants or the root systems of one or more plants (e.g., a potted plant in soil). The visual display is attached to the container and has an activation mechanism that responds to the moisture level in the pot (e.g., in the soil contained in the pot). For example, the display is active while there is adequate water in the container, but deactivated when it is time to water the contained plant. In an embodiment, the image display sequence runs according to user input, and a special warning image is activated to inform the user of the need to add water to the contained plant. In an embodiment, the activation mechanism is sensitive to an upper limit of liquid (e.g., water) present in the container. For example, the activation mechanism displays a different image to let the user know that an adequate level of water has been added (or moisture present) to the container (e.g., soil/plant). In an embodiment, the display shows a meter or other presentation of a metric related to the liquid/moisture level. In an embodiment, the display shows information about the plant inside the container (e.g., care instructions, interesting facts, etc.). Other embodiments of a container with associated visual display are possible.

FIG. 1B illustrates another example embodiment of the present invention. Here, the flexible display device 140 is shown as a rectangular object. However, the flexible display device 140 can be a different shape. The flexible display device 140 is attached to a host object of any shape (e.g., 114 or 116). For example, FIG. 1B shows the flexible display device 140 curving into a cylindrical shape. The flexible display object 140 can attach directly to the host object. Alternatively, the flexible display object 140 interlocks only with itself and attach to the host object by way of the tension or friction created by a proper fit over the object. The flexible display device 140 may have one or more connectors 150a, and one or more reciprocal connectors 150b. Or, as mentioned, the reciprocal connectors may be on the actual host object. The connectors 150 can be any connector, such as buttons, snaps, hook-and-loop fasteners, hooks, clasps, magnets, strings, etc. FIG. 1B shows the flexible display device 140 interlocked with itself via connectors 150a and 150b and attached to host object 114. The flexible display device 140 can be attached to any shape display device (e.g., host device 116). In an embodiment, the flexible display device 140 is controlled remotely (e.g., by an infrared remote or cell phone). In an embodiment, the flexible display device 140 has soft keys (e.g., touch-screen buttons) built into the flexible display device 140. In an embodiment, flexible display device 140 has an activation device, such as via a soft key and/or sensor, e.g., a heat sensor, light sensor, pressure sensor, connection sensor, etc. This way, the flexible display device 140 activates, for example, based on the warmth of the host device (e.g., a person or coffee mug), based on pressure (e.g., the tightening of being attached to the host device), and/or based on the connectors 150a being connected to reciprocal connectors 150b. Other activation mechanisms are possible, e.g., as discussed herein with respect to other example embodiments.

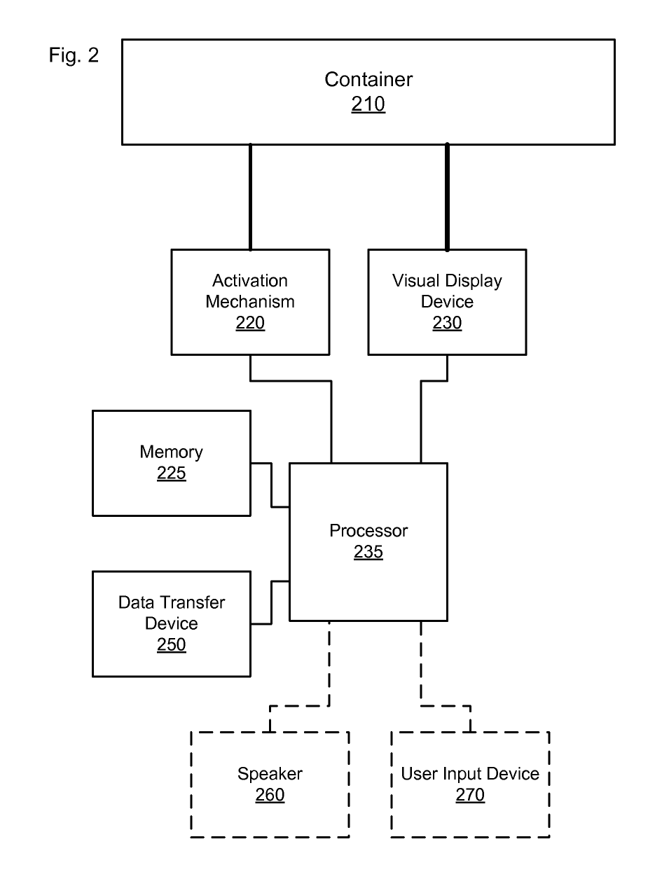

FIG. 2 illustrates a functional block diagram representing an example embodiment of the present invention. Block 210 illustrates a container (e.g., a cup, a pot, a basket, a compressed gas canister, a pitcher, etc.). The container 210 has a visual display device 230 attached, connected, or otherwise associated with container 210. In an embodiment, the container has one or more substantially flat surfaces (e.g., 510, 520, or 530), may be substantially round with a flat visual display device 230 (e.g., 540), and/or may have a visual display device 230 with a shape that is substantially not flat (e.g., 550). Curved or otherwise shaped display screens are generally known in the art as e-ink, electronic paper, or similar, and may be used. Other available visual display device technology may be used in a specific implementation of an embodiment of the present invention.

The visual display device 230 may cover the whole container 210 or a portion of the container 210. The visual display device 230 is associated with a processor 235 (e.g., one or more microprocessors). The processor 235 facilitates the various functions of the visual display device system that is attached to the container 210. The processor 235 communicates with an activation mechanism 220. In an example embodiment, the activation mechanism 220 is attached or otherwise associated to the container 210. In alternative example embodiments, the activation mechanism 220 is not physically attached to the container 220. One example activation mechanism 220 is a user input button (e.g., 170). In an embodiment, the activation mechanism 220 is a pressure sensor connected to the bottom of container 210 which activates responsive to added weight (e.g., pouring coffee into a mug or filling a compressed gas canister). In an embodiment, the activation mechanism 220 is connected to the container 210 in such a way as to measure changes in temperature. The activation mechanism 220 is responsive to hot and/or cold items (e.g., liquid) being placed inside the container 210. For example, activation mechanism 220 is responsive to any number of other things as well, e.g., the passage of time, light, touch, moisture density, liquid level, voice activation, touch screen activation, remote activation, etc.

In an embodiment, activation mechanism 220 acts as the deactivation mechanism for the example system. The example system may have more than one activation mechanisms 220, and/or more than one deactivation mechanisms. In an embodiment, a hot liquid causes a temperature based activation mechanism to activate the visual display device 230. In an embodiment, the same activation mechanism 220 deactivates the visual display device upon the liquid cooling beyond some configurable threshold. In an embodiment, a second mechanism responsive to the passage of time keeps the visual display device active for at least some configurable amount of time. In an embodiment, activation and deactivation is a binary function of one or more activation and/or deactivation mechanisms. For example, after heat based activation, deactivation occurs after 10 minutes and 10 degrees of cooling. Alternatively, deactivation may be set to occur after 10 minutes or 10 degrees of cooling.

In an embodiment, processor 235 is connected to memory 225. Memory 225 can include one or more RAMs, ROMs, disks, solid state memory devices, or any other memory device capable of storing digital information. In an embodiment, in addition to facilitating the memory needs of the example system (e.g., memory storage for cache faults of the processor 235), memory 225 also stores visual content to be displayed on the visual display device 230. The example system may have a speaker 260 (e.g., 160) capable of playing audio. In an embodiment, memory 225 stores data corresponding to audio (e.g., an MPEG-1 Audio Layer 3 (“MP3”) or other audio format). Memory 225 can store images, video, audio, graphics, games, an operating system, etc. Memory 225 can also act as a buffer for streaming data, (e.g., streaming video). The example system may also have a user input device 270 (e.g., 170) that performs the same function, additional functions, and/or totally different functions as activation mechanism 220. For example, user input device 270 allows a user to select what images to display, to delete images, reorder images, transmit images, make selections (e.g., moves in a game), etc. In an embodiment, user input device 270 is a wireless signal receiver (e.g., infrared (IR) signals), which allows the example system to be controlled by a remote (e.g., an IR transition device). Other remotes are possible, such as a wireless (e.g., Bluetooth™, CDMA, GSM, or any other wireless protocol) connection with a cellular device. In an example embodiment, a user is able to control the example system remotely, e.g., from his or her cellphone or other wireless handheld device or any other device (e.g., desk computer, Internet storage, Internet service provider).

An example system includes a data transfer device 250. This device can be a port for a wired connection, or a wireless connection device (e.g., Bluetooth™, wi-fi, etc.). The data transfer device 250 sends and receives data responsive to any number of things. For example, data transfers are responsive to user input indicating a desire to transfer data. For example, data transfers are responsive to a remote device interfacing with the example system. For example, data transfers are responsive to the example system coming within a specific proximity or connected to an external device (e.g., a device synchronization or other automatic data transfer). In an example embodiment, the example system transfers data responsive to coming in physical contact with another example system or other device configured to interface with the example system. Though the transfer described is responsive to physical contact, the actual transfer may be performed either wirelessly or through a physical medium (e.g., a wire or the physical connection made by the physical contact). In an embodiment, the data to be transferred includes all data, user selected data, some other subset of data, and/or the visual data currently displayed on at least one of the devices. An example embodiment is two coffee mugs with attached visual display devices 230. A first person, holding the first coffee mug, loads a picture of someone or something (e.g., a child, sibling, pet, vacation destination, recent date, game, calendar, etc.). The two people then simply tap their mugs together, which causes the visual content on the first mug to transfer to the second mug (e.g., for the second person to view). In an embodiment, any displayed visual content on the second mug is transferred automatically to the first mug. Other configurations or user selected options may cause the transfer of more content. Further, other transfer activation mechanisms can be used in addition to or as alternatives to the physical contact of two devices.

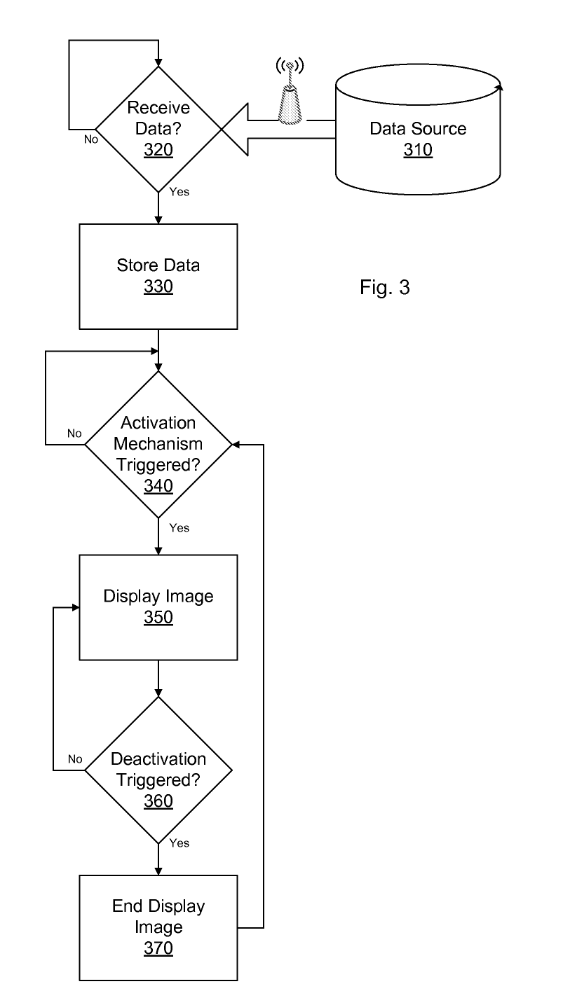

FIG. 3 illustrates an example method and/or system for how an example system can function. At 320, the example procedure waits to receive data from a data source 310. At 330, the example procedure stores the data to a local memory (e.g., 225). Next, at 340, the example procedure waits for an activation mechanism to be triggered. Upon activation, at 350, the example procedure displays an image or any other visual content comprising the received data. At 360, the example procedure continues to display the visual content at 350 until a deactivation mechanism is triggered. Once the deactivation mechanism is triggered, at 370, the example procedure ends the display of the visual content and returns to waiting for activation again at 340. This is an illustrative example shown in a consecutive order. An example embodiment can include constantly checking for incoming data, activation mechanisms, deactivation mechanisms, and/or other user system functions.

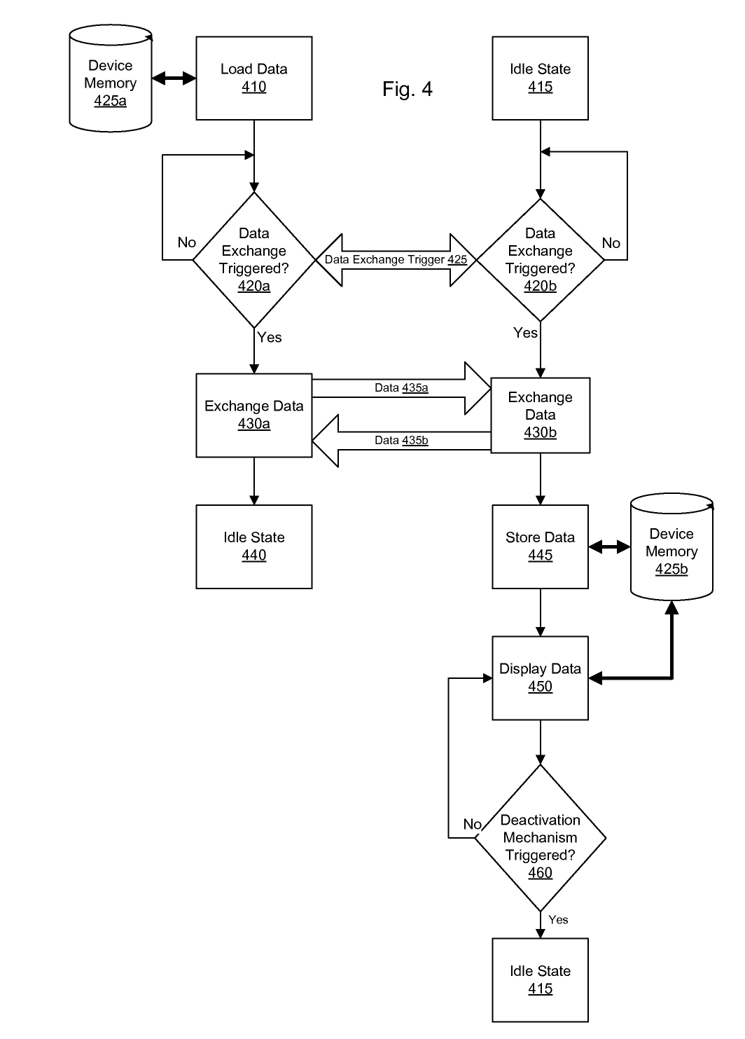

FIG. 4 illustrates an example method and/or system of how two example systems can function together. Each consecutive line of FIG. 4 represents an example procedure running on an example system. At 410, the example procedure loads data from device memory 425a. For example, a user with a coffee cup embodiment of the present invention loads a picture of a recent vacation. In an embodiment, a second user has a coffee cup embodiment of the present invention, or some other device configured to interact with the first example embodiment. The second device is in an idle state at 415. The devices wait for a data exchange trigger at 420a and 420b. Upon activation of the data exchange trigger 425, the two devices advance to a data exchange step 430a and 430b. This is, for example, activating some data transfer feature via button, physical contact of the two devices, or any other input command configured to begin a data transfer. In this example embodiment, the example procedures are configured to each exchange data with each other, i.e., 435a and 435b. In an embodiment, a one way transfer of data is involved. At 440, since the second example procedure did not have data loaded for exchange, the first example procedure enters an idle state. Other example embodiments may continue to display the exchanged data, original data, or some other data. At 445, the second example procedure stores the received data 435a in the device memory 425b of the second example system. This can be temporary cache, RAM, etc., or can be more stable solid state, disk, EPROM, etc. The second example procedure then displays the stored data, at 450. At 460, the example procedure continues to display the data until a deactivation mechanism is triggered, and then returns to an idle state 415.

Example illustrations of image display have been given. However, it should be appreciated that the data transfer mechanisms may be capable of transferring or may transfer other forms of data, such as game play data to facilitate a multiplayer game experience using example systems and procedures.

The disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor which, when executing the series of computer instructions, performs or facilitates the performance of all or part of the disclosed methods and procedures.

It should be understood that there exist implementations of other variations and modifications of the invention and its various aspects, as may be readily apparent to those of ordinary skill in the art, and that the invention is not limited by specific embodiments described herein. Features and embodiments described above may be combined. It is therefore contemplated to cover any and all modifications, variations, combinations or equivalents that fall within the scope of the basic underlying features disclosed and claimed herein.

What is claimed is:

1. A system, comprising:
a visual display device having a visual display, wherein the visual display device is configured to be associated with a container;
an activation mechanism, the activation mechanism being associated with the visual display device;
at least one connector configured to cause the visual display device to be associated with the container;
a memory associated with the visual display device and adapted to store digital content; and,
a data transfer device associated with the visual display device for at least one of transmitting data and receiving data wirelessly.

2. The system of claim 1, wherein the activation mechanism is responsive to at least one of: weight, temperature, liquid, pressure, and motion.

3. The system of claim 1, wherein at least one side of the container is curved, the visual display device being configured to be attached to the at least one side of the container that is curved.

4. The system of claim 3, wherein the visual display device is substantially similar in shape to the at least one side of the container that is curved.

5. The system of claim 1, wherein the visual display device is flexible.

6. The system of claim 1, wherein at least one side of the container is substantially flat, the visual display device being configured to be connected to the at least one side of the container that is substantially flat.

7. The system of claim 1, wherein the data transfer device is configured to send and receive data to and from another device responsive to the container coming in contact with the other device.

8. The system of claim 1, wherein the visual display device is configured to display at least one of: images, video, news, weather, a graphical user interface, game displays, maps, traffic conditions, user information, a personal profile, a dating profile, a social networking profile, consumer information, recipes, beverage information, nutritional values, and a Web browser.

9. The system of claim 1, wherein the container is configured to hold a second container, the second container being removable from the first container.

10. The system of claim 1, wherein the container is configured with a hollow portion adapted to contain a quantity of matter, wherein the visual display responds according to the quantity of matter contained within the hollow portion of the container.

11. The system of claim 10, wherein the quantity of matter is a quantity of liquid having an upper surface, and wherein the visual display responds by one of: only displaying a portion of the visual display that is below the upper surface and by only displaying a portion of the visual display that is above the upper surface.

12. The system of claim 1, wherein the container is adapted to hold at least one permeable substance, and wherein the activation mechanism is responsive to a moisture quantity in the at least one permeable substance.

13. The system of claim 1, further comprising:
a speaker connected to the memory and adapted to produce audio responsive to accessing at least some of the data contained in the memory.

14. The system of claim 1, further comprising:
a container, wherein the visual display device is attached to the container.

15. A method, comprising:
receiving visual data responsive to an activation mechanism wirelessly; and
displaying the visual data on a visual display device associated with a container responsive to the activation mechanism,
wherein the activation mechanism is a sensor which activates at least one of the receiving of and the displaying of visual data.

16. The method of claim 15, wherein the sensor is responsive to at least one of: weight, temperature, liquid, pressure, and motion.

17. The method of claim 15, wherein at least one side of the container is curved, and wherein the displaying occurs on the at least one side of the container that is curved.

18. The method of claim 17, wherein the displaying includes a display surface that is curved.

19. The method of claim 18, wherein the display surface is substantially similar in shape to the at least one side of the container that is curved.

20. The method of claim 15, wherein at least one side of the container is substantially flat, and wherein the visual display device is connected to the at least one side of the container that is substantially flat.

21. The method of claim 15, wherein the transmitting occurs with a second device and is at least responsive to the container coming in contact with the second device.

22. The method of claim 15, wherein the visual entity includes at least one of: images, video, news, weather, a graphical user interface, game displays, maps, traffic conditions, user information, a personal profile, a dating profile, a social networking profile, consumer information, recipes, beverage information, nutritional values, and a Web browser.

23. The method of claim 15, wherein the container is configured to hold a second container.

24. The method of claim 15, wherein the container is configured with a hollow portion adapted to contain a quantity, wherein the displaying includes adjusting the visual entity according to the quantity contained within the hollow portion of the container.

25. The method of claim 24, wherein the quantity is a quantity of liquid having a surface, and wherein the adjusting includes one of: only displaying a portion of the visual entity that is below the surface and only displaying a portion of the visual entity that is above the surface.

26. The method of claim 15, wherein the container is adapted to hold at least one permeable substance, and wherein the activation mechanism is responsive to a moisture quantity in the at least one permeable substance.

27. The method of claim 15, further comprising:
producing audio responsive to accessing at least some of the data contained in a memory associated with the visual display device.
